(19) United States
(12) Patent Application Publication
(10) Pub. No.: US 2025/0269823 A1
(43) Pub. Date: Aug. 28, 2025

(54) Initiating a Cleaning Process While Taking into Consideration the Surroundings

(71) Applicant: Robert Bosch GmbH, Stuttgart (DE)

(72) Inventors: Johann Klaehn, Mannheim (DE); Stephan Lenor, Gerlingen (DE)

(21) Appl. No.: 18/693,201

(22) PCT Filed: Sep. 22, 2022
(86) PCT No.: PCT/EP2022/076447

§ 371 Date: Sep. 6, 2024

(30) Foreign Application Priority Data
Sep. 23, 2021 (DE) 10 2021 210 612.9

(51) Int. Cl. B60S 1/56

(52) U.S. Cl. CPC B60S 1/56

(57) ABSTRACT

A method is for initiating a cleaning process of at least one vehicle-side sensor using a control unit. Ascertained measurement data is received from at least one surroundings sensor, a cleaning request is received from at least one requesting unit, and the surroundings of the vehicle are checked with respect to at least one unit to be protected in the surroundings of the vehicle based on the received measurement data and/or the at least one unit to be protected is ascertained based on other received data. When the at least one unit to be protected is ascertained in the surroundings of the vehicle, a modified cleaning process is initiated and/or the initiation of the cleaning process is delayed or prevented.

The invention relates to a method for initiating a cleaning process of at least one vehicle- side sensor by a control unit. The invention also relates to a control unit and a vehicle system.

### PRIOR ART

Due to the increasing automation of vehicles, the number of surroundings sensors required to implement automated driving functions is growing. Performance losses and sensor failures due to absorbing or scattering media at close range, such as dust, rainwater or ice, must be avoided, especially in vehicles without a driver as a fallback.

It is therefore crucial for the availability and therefore in particular the cost-effectiveness of surroundings sensors to utilize options for keeping sensors free and for sensor cleaning. Methods are currently known for keeping the sensor clear, for example by wiping the windshield cyclically when it rains, or for cleaning the sensor, for example by washing and wiping the windshield when it is soiled.

The initiation of such cleaning processes by teleoperators in the absence of a driver is difficult to manage for larger vehicle fleets due to the need for coordination. Cleaning processes of surroundings sensors could also be triggered automatically by signals from a centralized or decentralized soiling detection system. However, such methods do not take the vehicle's surroundings into consideration and can, for example, lead to pedestrians being soiled or electrical systems being damaged.

### DISCLOSURE OF THE INVENTION

The task underlying the invention can be seen in the creation of a method for initiating a cleaning process which takes into account what is happening in the surroundings of the vehicle.

This object is achieved by the subject matter of the independent claims, respectively. Advantageous embodiments of the invention are the subject of dependent claims.

According to one aspect of the invention, a method for initiating a cleaning process of at least one vehicle-side sensor by a control unit is provided. The vehicle-side sensor can preferably be a surroundings sensor. The at least one surroundings sensor can, for example, be a LIDAR sensor, a radar sensor, a camera sensor, an ultrasonic sensor and the like.

In one step, measurement data ascertained by at least one surroundings sensor and a cleaning request from at least one requesting unit are received.

Surroundings of the vehicle are checked based on the measurement data received with respect to at least one unit to be protected in the surroundings of the vehicle.

If at least one unit to be protected is ascertained in the surroundings of the vehicle, the cleaning process is initiated with a delay and/or modified or the cleaning process is aborted. For example, a modified cleaning process can be carried out with a reduced water input. In addition, the modified cleaning process can be carried out in such a way that only a limited number of cleaning nozzles are activated so as not to impair the unit to be protected. The modified cleaning process can be delayed in terms of time or location or carried out without a time delay.

According to a further aspect of the invention, a control unit is provided which is adapted to carry out the method according to the invention.

According to a further aspect of the invention, a vehicle system is provided. The vehicle system has a control unit and at least one automated cleaning system or a cleaning device for at least one vehicle-side surroundings sensor.

The method allows external circumstances to be taken into account when carrying out cleaning processes. In particular, data and information from the surroundings of the vehicle can be used to prevent damage to the surroundings or neighboring units. This means, for example, that pedestrians in the vicinity of automated vehicles can be spared from being sprayed with cleaning water, motorcyclists are not unnecessarily distracted when overtaking and unfavorable cleaning processes in buildings can be avoided.

The control unit can be installed in a vehicle, for example. The vehicle can in this case be operated in an assisted, partially automated, highly automated and/or fully automated, or driverless, manner in accordance with the BASt standard.

In addition, the vehicle can be equipped with at least one self-cleaning system that can clean at least one surroundings sensor. Such a cleaning system can, for example, comprise cleaning water nozzles, windshield wipers, compressed air nozzles and the like in order to be able to automatically clean surfaces, such as glass panes, of surroundings sensors.

In particular, the control unit can incorporate sensor information from the surroundings of an automated or semi-automated vehicle in order to carry out cleaning that has as little an impact as possible on the surroundings. This involves recording the surroundings of the vehicle with surroundings sensors and using the sensor data to check for units to be protected. If a cleaning request occurs that could affect entities or units to be protected, the damage can be avoided by aborting or delaying the cleaning process. If people are involved in this process, in particular pedestrians, cyclists, motorcyclists, children, wheelchair users and the like, they can be warned alternatively or additionally by loudspeakers or warning systems of the vehicle. For this purpose, the control unit can generate corresponding control commands to issue a warning.

If cleaning has been ordered by a person, such as a teleoperator or a vehicle passenger, they can explicitly confirm the cleaning process by asking the control unit if entities to be protected are present.

An entity to be protected can be, for example, a person, a device or an apparatus. For example, the entity to be protected can be a cyclist, a pedestrian, a motorcyclist, a wheelchair user, a child, an animal, an object parked on the side of a road, such as a suitcase or moving objects, an electrical installation and the like.

The method enables automated vehicles in particular to behave considerately, which promotes their social acceptance and thus their success on the market. In addition, such considerate cleaning can reduce the secondary cleaning requirements in the surroundings, for example clothing, building walls, building floors, and thus conserve resources.

By taking the vehicle's surroundings into account when initiating the cleaning process, road safety can be increased, as cyclists or motorcyclists, for example, are not impaired or distracted by cleaning water in unfavorable traffic situations.

In one exemplary embodiment, the cleaning request is generated by a requesting unit in the form of a vehicle-external operator, a vehicle-internal passenger, a vehicle-external control unit and/or a vehicle-internal control unit and received by the control unit. A cleaning requirement or cleaning request is identified by at least one requester or requesting unit and sent to the control unit as a cleaning request. Persons or operators or devices or control units or a combination of both can act as a requesting unit. The requesting unit can be located inside or outside the vehicle. Depending on the design, the requesting unit can also be integrated into the vehicle-internal or vehicle-external control unit, for example in the form of a requesting unit module.

The vehicle system can have several vehicle-internal and/or vehicle-external requesting units, each of which can address at least one cleaning system or request cleaning. The respective requesting units do not necessarily have to make the same decisions or send the same cleaning requests.

According to a further embodiment, if an entity or unit to be protected is ascertained in the surroundings of the vehicle, an impairment of the unit by the cleaning process is ascertained, wherein the cleaning process is initiated if the impairment by the cleaning process is negligible or is accepted to ensure road safety. This makes it possible to weigh up the urgency of cleaning, for example for safety reasons, against damage to the unit to be protected. If, for example, a cleaning process has to be initiated in order to maintain the functionality of an essential surroundings sensor, the impairment of entities to be protected can be suspended or accepted. This can prevent accidents caused by contaminated sensors.

According to a further embodiment, a degree of impairment of the entity to be protected is ascertained by a cleaning process. The initiation of the cleaning process is delayed or aborted if the degree of impairment ascertained exceeds a threshold value. Alternatively or additionally, the cleaning process can be carried out in a modified form in order to prevent impairment of the protected unit. However, the cleaning process is initiated if the degree of impairment ascertained falls below the threshold value.

The impairment or the degree of impairment of the unit to be protected can, for example, take the form of a degree of soiling or a probable degree of damage. If the expected impact of the cleaning process on the surroundings or unit to be protected is sufficiently small or non-existent, the cleaning can be carried out without additional delay. If the expected damage to the surroundings to be protected is greater than a predefined threshold value, the method can initiate a delay or suspension in order to limit the damage.

The damage may take the form of an anticipated cleaning job to clean items of clothing or, for example, to clean walls or floors in a parking garage, an anticipated repair job of unprotected electrical installations and the like.

According to a further exemplary embodiment, the initiation of the cleaning process is delayed by a warning and/or confirmation prompt from the requesting unit.

According to a further embodiment, the initiation of the cleaning process is delayed by a warning from the ascertained unit in the vehicle surroundings to be protected.

This allows the control unit to question the request of the at least one requesting unit in the form of a query or to warn people in the vicinity of the vehicle, for example by means of a loudspeaker output. These measures allow a mobile unit to be protected in particular to gain a distance from the vehicle.

Alternatively or additionally, the additional delay can help the vehicle with the vehicle system to move away from the unit to be protected, for example by following its planned trajectory or taking an unplanned evasive trajectory.

According to a further exemplary embodiment, the delayed and/or modified cleaning process is initiated at a later time or at an offset position on the vehicle side based on a cleaning schedule. This measure can be used to delay the initiation of the cleaning process in the form of a temporal and/or spatial delay. A spatial delay can be implemented by setting a predefined distance between the entity to be protected and the vehicle. This can be done, for example, by setting a predefined distance from which it is unlikely that the entity to be protected will be impaired. A time delay in the initiation of the cleaning process can be realized by the expiry of a predefined period of time after the entity to be protected has passed. The cleaning measure is therefore only initiated when the time period has expired and a distance between the vehicle and the entity to be protected has been set based on the time period.

If necessary, the cleaning process can be carried out in a modified form in which, for example, a smaller number of cleaning nozzles or a reduced amount of water is used.

According to a further embodiment, the surroundings of the vehicle is checked based on the received measurement data with respect to at least one unit to be protected in the form of a pedestrian, a road user, in particular a two-wheeler rider, sensors of road users, sensors of infrastructure units, infrastructure sections, buildings, interiors of buildings, parking garages, electrical systems in the surroundings of the vehicle. As far as possible, all boundary conditions that need to be taken into account as a considerate cleaning system in a vehicle are taken into account.

Alternatively or in addition to receiving measurement data, data can be received from a memory or an external server unit according to a further embodiment. For example, map data can be received in order to localize and/or identify entities to be protected. An entity to be protected can also be surroundings to be protected that are affected by a cleaning process. This allows the initiation of cleaning processes in pedestrian zones or crosswalks to be delayed, prevented or a cleaning process to be carried out in a modified form. Receiving measurement data would not be necessary for such stationary or known entities to be protected.

For example, the method can prevent a passenger approaching the vehicle with an autonomous cleaning system from being carelessly frightened or impaired by a cleaning process spraying in their direction. This ensures a positive impression of the product on the customer.

A motorcyclist following the vehicle is also ascertained as an entity to be protected, so that suspending or delaying the cleaning process prevents a motorcyclist's visor from being soiled by indirect cleaning water and the motorcyclist from being impaired or frightened. The method also prevents cyclists from being impaired in tight city traffic. This contributes to increased road safety.

As a further option, indoor areas of buildings such as workshops, parking garages, airport terminals, car dealerships and the like can be ascertained by the control unit as units to be protected in order to interrupt or cancel automatic cleaning processes. In a car dealership, for example, this can protect electrical systems, employees or customers from soiling caused by vehicle cleaning processes. This behavior contributes to a positive product image and greater safety.

According to a further exemplary embodiment, control commands are generated by the control unit to initiate the cleaning process and transmitted directly or indirectly to at least one actuator. The control unit can be used for direct control of actuators, such as pump motors, compressor motors, electrically controllable valves and the like, or for indirect control of actuators by upstream control units or drivers.

According to a further embodiment, the cleaning process is initiated immediately if no unit to be protected is ascertained in the surroundings of the vehicle or if no impairment of the unit to be protected by the cleaning process is ascertained. If there are no units to be protected in the vicinity of the vehicle, the cleaning process can be initiated without restriction if the at least one requesting unit transmits a corresponding cleaning request to the control unit.

Preferred exemplary embodiments of the invention are described in greater detail below, with reference to highly simplified schematic illustrations. Shown are:

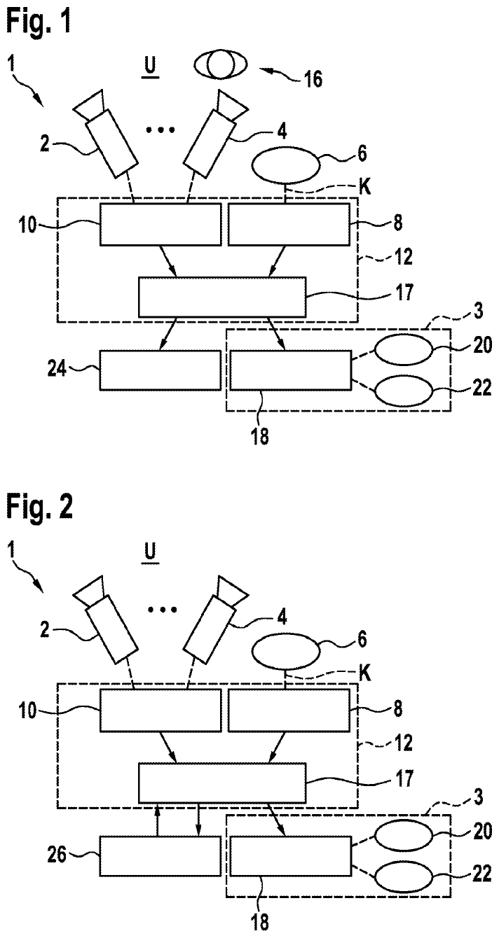

FIG. 1 a schematic representation of a vehicle system for illustrating a method according to a first embodiment,

FIG. 2 a schematic representation of a vehicle system for illustrating a method according to a second embodiment,

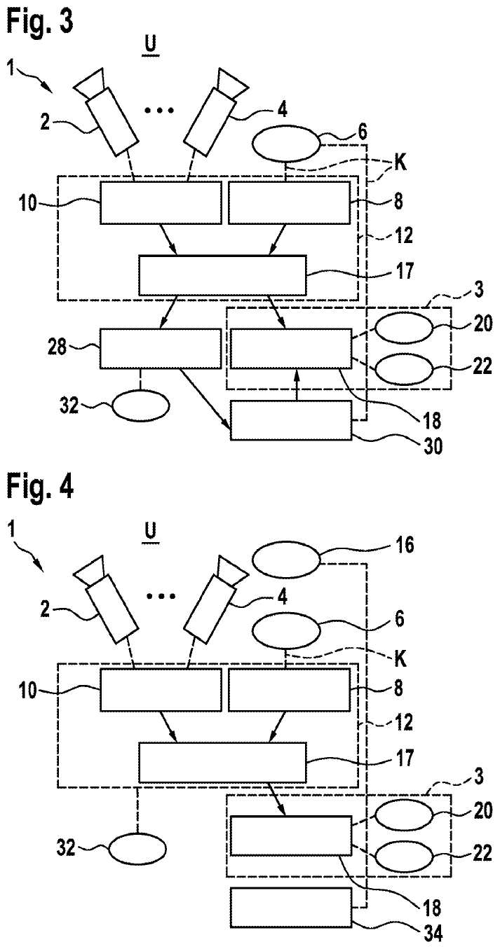

FIG. 3 a schematic representation of a vehicle system to illustrate a method according to a third embodiment,

FIG. 4 a schematic representation of a vehicle system for illustrating a method according to a fourth embodiment,

FIG. 1 shows a schematic representation of a vehicle system 1 for illustrating a method according to the invention for initiating a cleaning process of at least one vehicle-side sensor 2, 4 according to a first embodiment. The vehicle system 1 is preferably integrated in a vehicle not shown or can be used in a vehicle.

In the exemplary embodiment shown, the vehicle system 1 has two camera sensors that act as surroundings sensors 2, 4. The vehicle system 1 is not limited to a specific number or type of surroundings sensors 2, 4. LIDAR sensors, radar sensors, ultrasonic sensors, microphones and the like are also possible surroundings sensors for recording the surroundings of the vehicle U. The surroundings sensors 2, 4 are used to ascertain sensor data or measurement data 10. These measurement data 10 are transmitted to a control unit 12, which is set up to evaluate the measurement data 10.

A requesting unit 6 can send a cleaning request 8 to the vehicle system 1 or to at least one cleaning system 3 of the vehicle system 1. A requesting unit 6 can be a component of the vehicle system 1 or an external requesting unit 6. In particular, a requesting unit 6 configured as a passenger or as a human teleoperator can be assigned to an external requesting unit 6. In addition, the requesting unit 6 can be designed as an vehicle-side control unit or a vehicle-external control unit.

A requesting unit 6 designed as a human teleoperator in the backend can make a cleaning decision based on the sensor data and/or system performance data transmitted to it and/or automatically suggested cleaning requests and/or from other sources, such as weather information.

A requesting unit 6 designed as a control unit can automatically generate cleaning requests. This is done, for example, using sensor data and/or system performance data and/or weather information ascertained by the vehicle. A requesting unit 6 designed as an external control unit or cloud can transmit corresponding cleaning requests to the vehicle via a wireless communication link K.

Based on the received measurement data 10, the surroundings of the vehicle U is checked with respect to at least one unit 16 in the surroundings of the vehicle U that is to be protected. This step is implemented by the control unit 12.

Alternatively or additionally, entities 16 to be protected can be identified or ascertained based on received data. The data can be map data, for example, and can be obtained from external server units or from a memory. Such entities to be protected 16 can be, for example, places or surroundings that have a large number of people, such as crosswalks. The cleaning measures can be suspended, delayed or implemented in a modified form at such stationary or upstream locations.

Types of units to be protected 16 that can occur in the surroundings of the vehicle U and are taken into account during cleaning processes can be, for example, people, viewing windows of vehicles, sensors, buildings and the like, electrical systems and installations, soil, animals, plants, walls and floors and the like. Examples of units 16 to be protected as people are passengers, pedestrians, cyclists, motorcyclists, electric scooter drivers, workshop employees, customers in car dealerships, cleaning staff, postmen and women and the like.

The control unit 12 can ascertain or identify such units to be protected 16 as part of a data evaluation 17 of the measurement data 10. In particular, such data evaluation 17 can be realized by a single control unit 12 or by several distributed control units.

If no unit to be protected 16 is identified in the surroundings of the vehicle U, the control unit 12 can initiate the cleaning process 18. For this purpose, drivers or control units 20 and/or actuators 22 of the cleaning system 3 can be controlled by the control unit 12.

The cleaning system 3 is preferably designed as an automated cleaning system and can be fully automated. Optionally, the cleaning system 3 can be activated by human-initiated control commands.

A controller 20 may have one or more computing units and may have control and communication channels to the actuators 22.

The actuators 22 for wet and/or dry cleaning or serve to implement the actual cleaning process 18. For example, wiper motors and wipers, pumps, valve blocks, spray nozzles, water tanks, air compressors, centrifugal freewheels or rotary motors and the like can be used as actuators 22 in any combination and integration.

If a unit to be protected 16 is registered during data processing 17, the control unit 12 causes the cleaning process 18 to be aborted 24 or the cleaning request 8 to be rejected in the exemplary embodiment shown.

During data processing 17, the control unit 12 can calculate a movement model of the vehicle, the units to be protected 16 in the surroundings of the vehicle U and a cleaning agent during the cleaning process 18, whereby wind and driving dynamics can also be taken into account. The expected amount of waste water from the cleaning process 18 can also be taken into account, for example if a windshield wiper only removes a small amount of water in light rain and does not affect the surroundings.

Optionally, a planning of the cleaning process 18 or of cleaning processes can be carried out taking into account all boundary conditions, not only those for protecting the surroundings, in order to predict a time of the cleaning process.

FIG. 2 shows a vehicle system 1 which illustrates a method according to a second embodiment. In contrast to FIG. 1, a delay 26 of the cleaning process 18 is initiated by the control unit 12. The delay 26 may be a temporal and/or spatial delay, by which a degree of impairment of the unit to be protected 16 is to be minimized.

This enables a potential passenger to board the vehicle comfortably, for example. A windshield cleaning process 18 is suppressed when the vehicle is stationary, for example, as soon as a person (as an entity to be protected 16) approaches the vehicle.

The method can increase road safety and consideration in overtaking situations and for traffic behind. In road traffic, it is mainly during overtaking maneuvers, following or stop-and-go traffic that other vehicles temporarily come within the range of the cleaning system 3. In such situations, uncontrolled cleaning, amplified by the airstream, can lead to the applied cleaning water impairing the view of other road users or distracting them. For example, ultrasonic sensors or close-range cameras of a blind spot or parking assistant, or a rear camera, can be used to detect such situations. Finally, the cleaning process 18 can be triggered with a time delay so that other road users as units to be protected 16 are not affected.

Similarly, people and objects in the immediate vicinity of the vehicle can be protected. Within cities or on factory premises, parking lots or service areas, there may be units to be protected 16 in the form of people and openly transported or parked objects in the vicinity of the vehicle when parking or driving at low speed. In such situations, for example, postmen and women, deposited briefcases, openly transported goods or sensitive electrical installations, such as cable drums, open distribution boxes during road and maintenance work and the like, can be detected and lead to a delay 26 in the cleaning process 18.

Accordingly, data processing 17 can register the performance of maintenance work on the vehicle system 1 or on the vehicle. During such maintenance work, for example when replacing wiper blades, manually cleaning the windshield, attaching toll stickers, automated cleaning can be suppressed by the cleaning system 3.

FIG. 3 shows a schematic representation of a vehicle system 1 to illustrate a method according to a third embodiment. In contrast to the exemplary embodiments already shown, a warning 28 is transmitted to a human requesting unit 6 by the control unit 12 because an entity to be protected 16 is present in the surroundings of the vehicle U. The warning 28 can also be transmitted to the requesting unit 6 via the communication link K. In addition, a confirmation request 30 can be transmitted to the requesting unit 6 to force the initiation of the cleaning process 18.

Optionally, control commands for activating an audio and/or visual warning unit 32 of the vehicle and/or the vehicle system 1 can be generated by the control unit 12 in parallel with the confirmation request 30. This can warn the surroundings of the vehicle U and, in particular, units to be protected 16 within the surroundings of the vehicle U, of an imminent cleaning process 18.

FIG. 4 shows a schematic representation of a vehicle system 1 for illustrating a method according to a fourth embodiment, in which the warning 28 and the confirmation request 30 of the requesting unit 6 are not carried out, but instead a direct activation of the audio and/or visual warning unit 32 is carried out by the control unit 12. This causes an evasion 34 of the unit to be protected 16.

1. A method for initiating a cleaning process of at least one vehicle-side sensor using a control unit, the method comprising:
receiving ascertained measurement data from at least one surroundings sensor;
receiving a cleaning request from at least one requesting unit;
checking the surroundings of the vehicle with respect to at least one unit to be protected in the surroundings of the vehicle based on the received measurement data and/or the at least one unit to be protected is ascertained based on received data; and
when the at least one unit to be protected is ascertained in the surroundings of the vehicle, initiating a modified cleaning process and/or delaying or preventing the initiation of the cleaning process.

2. The method according to claim 1, further comprising:
generating the cleaning request using the at least one requesting unit in the form of a vehicle-external operator, a vehicle-internal passenger, a vehicle-external control unit, and/or a vehicle-internal control unit; and
receiving the generated cleaning request using the control unit.

3. The method according to claim 1, further comprising:
when the at least one unit to be protected is ascertained in the surroundings of the vehicle, ascertaining an impairment of the at least one unit to be protected by the cleaning process; and
initiating the cleaning process when the ascertained impairment is negligible or is accepted in order to ensure road safety.

4. The method according to claim 3, further comprising:
ascertaining a degree of impairment of the at least one unit to be protected by the cleaning process;
delaying or aborting the initiation of the cleaning process when the ascertained degree of impairment exceeds a threshold value; and
initiating the cleaning process when the ascertained degree of impairment falls below the threshold value.

5. The method according to claim 1, wherein the initiation of the cleaning process is delayed by a warning of the at least one requesting unit and/or a confirmation prompt of the at least one requesting unit.

6. The method according to claim 1, wherein the initiation of the cleaning process is delayed by a warning of the ascertained at least one unit to be protected in the surroundings of the vehicle.

7. The method according to claim 1, further comprising:
initiating the delayed cleaning process based on a cleaning schedule at a later time or at an offset position on the vehicle side.

8. The method according to claim 1, further comprising:
checking the surroundings of the vehicle based on the received measurement data with respect to the at least one unit to be protected in the form of a pedestrian, a road user, a two-wheeler rider, sensors of road users, sensors of infrastructure units, infrastructure sections, buildings, interiors of buildings, parking garages, and electrical installations in the surroundings of the vehicle.

9. The method according to claim 1, further comprising:
generating control commands using the control unit to initiate the cleaning process; and
transmitting the generated control commands directly or indirectly to at least one actuator of a cleaning system.

10. The method according to claim 3, further comprising:
initiating the cleaning process immediately when no unit to be protected is ascertained in the surroundings of the vehicle or no impairment of the unit to be protected by the cleaning process is ascertained.

11. A controller configured to carry out the method according to claim 1.

12. A vehicle system, comprising:
a control unit according to claim 11; and
at least one automated cleaning system for at least one vehicle-side surroundings sensor.
